(19) United States
(12) Patent Application Publication
(10) Pub. No.: US 2021/0306166 A1
(43) Pub. Date: Sep. 30, 2021

(54) Network information transmission systems

(71) Applicant: MELLANOX TECHNOLOGIES TLV LTD., Raanana (IL)

(72) Inventors: Yonatan Piasetzky, Tel Aviv (IL); Matty Kadosh, Hadera (IL); Alan Lo, Shoresh (IL); Aviv Kfir, Nili (IL); Barak Gafni, Campbell, CA (US)

(21) Appl. No.: 16/833,715

(22) Filed: Mar. 30, 2020

(51) Int. Cl. H04L 12/06; H04L 12/46; H04L 12/775; H04L 29/06; H04L 29/08; G06F 13/38

(52) U.S. Cl. CPC H04L 12/06; H04L 12/4633; H04L 45/58; H04L 2212/00; H04L 69/325; G06F 13/385; H04L 69/169

(57) ABSTRACT

A network information transmission system. The network information transmission system includes a packet handling device including a control plane configured to open a remote direct memory access (RDMA) connection with a destination external to the network information transmission system, an encapsulator configured to encapsulate one or more packets traversing the packet handling device, producing one or more encapsulated packets, and a transmitter configured to transmit the one or more encapsulated packets, via the RDMA connection, to the destination external to the network information transmission system. Related apparatus and methods are also described.

### FIELD OF THE INVENTION

The present invention relates to networked system/s in general, and particularly but not exclusively to networked system/s which send information to a remote system, further particularly for remote diagnosis of issues in the networked systems.

### BACKGROUND OF THE INVENTION

Certain systems which send information to a remote system, in some cases for remote diagnosis of issues in the systems which send the information, are known.

### SUMMARY OF THE INVENTION

A system which sends network information to a location remote to the network or remote to a component of the network is also termed herein a “network telemetry system” (in various grammatical forms). The term “network telemetry system” is not meant to be limited to “telemetry” per se, but rather is to be understood in terms of the foregoing definition. Without limiting the generality of the foregoing, such information may include information which is useful for diagnosis of problems, status, or issues in the network system. Network information sent via a network telemetry system is also termed herein “network telemetry information” (in various grammatical forms).

The present invention, in certain exemplary embodiments thereof, seeks to provide improved systems and methods for network systems diagnosis, including improved network telemetry systems.

There is thus provided in accordance with an exemplary embodiment of the present invention a network information transmission system including: a packet handling device including a control plane configured to open a remote direct memory access (RDMA) connection with a destination external to the network information transmission system, an encapsulator configured to encapsulate one or more packets traversing the packet handling device, producing one or more encapsulated packets, and a transmitter configured to transmit the one or more encapsulated packets, via the RDMA connection, to the destination external to the network information transmission system.

Further in accordance with an exemplary embodiment of the present invention the packet handling device includes one of the following: a switch, and a router.

Still further in accordance with an exemplary embodiment of the present invention the one or more encapsulated packets include telemetry information.

Additionally in accordance with an exemplary embodiment of the present invention the packet handling device further includes a mirror decision unit configured to duplicate the one or more packets before encapsulation thereof, and the encapsulator encapsulates the one or more duplicated packets.

Moreover in accordance with an exemplary embodiment of the present invention the RDMA connection transits an internet protocol (IP) network.

Further in accordance with an exemplary embodiment of the present invention the RDMA connection includes a RDMA over converged Ethernet (RoCE) connection.

Still further in accordance with an exemplary embodiment of the present invention the RoCE connection includes one of: an unreliable connection (UC), and a reliable connection.

Additionally in accordance with an exemplary embodiment of the present invention the RoCE connection includes a RoCEv2 connection.

Moreover in accordance with an exemplary embodiment of the present invention destination external to the network information transmission system includes a collector system.

Further in accordance with an exemplary embodiment of the present invention the collector system includes a network element and collector memory.

Still further in accordance with an exemplary embodiment of the present invention the network element includes a network interface controller (NIC).

There is also provided in accordance with another exemplary embodiment of the present invention a network information transmission method including, in a packet handling device of a network information transmission system, opening a remote direct memory access (RDMA) connection with a destination external to the network information transmission system, encapsulating one or more packets traversing the packet handling device, producing one or more encapsulated packets, and transmitting the one or more encapsulated packets, via the RDMA connection, to the destination external to the network information transmission system.

Further in accordance with an exemplary embodiment of the present invention the one or more encapsulated packets include telemetry information.

Still further in accordance with an exemplary embodiment of the present invention the method further includes duplicating the one or more packets before encapsulation thereof, and wherein the one or more duplicated packets are encapsulated.

Additionally in accordance with an exemplary embodiment of the present invention the RDMA connection transits an internet protocol (IP) network.

Moreover in accordance with an exemplary embodiment of the present invention the RDMA connection includes a RDMA over converged Ethernet (RoCE) connection.

Further in accordance with an exemplary embodiment of the present invention the RoCE connection includes one of: an unreliable connection (UC), and a reliable connection.

Still further in accordance with an exemplary embodiment of the present invention the destination external to the network information transmission system includes a collector system.

Additionally in accordance with an exemplary embodiment of the present invention the collector system includes a network element and collector memory.

Moreover in accordance with an exemplary embodiment of the present invention the network element includes a network interface controller (NIC).

### BRIEF DESCRIPTION OF THE DRAWINGS

The present invention will be understood and appreciated more fully from the following detailed description, taken in conjunction with the drawings in which:

FIG. 1A is a simplified block diagram illustration of a network information transmission system constructed and operative in accordance with an exemplary embodiment of the present invention;

FIG. 1B is a partly pictorial, partly block-diagram illustration of a tap aggregation system, useful for understanding certain modes of operation of the exemplary embodiment of FIG. 1A;

FIG. 2 is a simplified flowchart illustration of an exemplary method of operation of the system of FIG. 1; and

FIG. 3 is a simplified flowchart illustration of an exemplary method of operation of a portion of the method of FIG. 2.

### DETAILED DESCRIPTION OF AN EMBODIMENT

By way of general introduction, it is believed that the following discussion represents a general overview of network information transmission systems (with telemetry systems being used as a particular non-limiting example); however, no statement made herein is meant to be a characterization of known art in the field:
In certain networks, network information is frequently or constantly collected, and may be sent as network telemetry information, in order to diagnose and treat problems that may arise in the network. Such collection and sending of network telemetry information may be done on a number of different timescales which are chosen in order to address various issues. For example, and without limiting the generality of the foregoing, hourly data can be stored and analyzed to monitor system health, while second-resolution data can be used to alert for link failures, etc. One possible configuration in such networks is for a local switch CPU, using cyclic direct memory access (DMA) to “digest” telemetry events and to send those events to some collector (typically, for analysis at the collector). Although the example of a switch is used herein for purposes of simplicity of description, it is appreciated that a router may alternatively be used in certain exemplary embodiments, mutatis mutandis. This configuration raises the problem of high switch CPU load requirements and is bound by the available bandwidth of packet processing in the switch CPU.
In another possible configuration, all telemetry events are tunneled as traffic to some collector, which needs to digest the received traffic and store the traffic somewhere. In this configuration, there may be problems of high CPU load in the collector, and the need to constantly pull data by the collector in order not to lose any required data (generally stored in non-cyclic memory).
Both configurations result in low speed of processing of telemetry data, and inability to handled high resolution data. Furthermore, at the collector side, the non-cyclic memory needs to be constantly “pulled” (read) in order to not lose relevant data.

In order to improve on the type of system discussed immediately above (such as, by way of non-limiting example, to enable performing of microburst analysis and real-time congestion control), collecting network information with microsecond resolution may be required. Current solutions relating to network information transmission systems are believed to be unable to cope with the required temporal resolution (microsecond) and with the required number of packets per second (pps) which would need to be transmitted.

In some exemplary embodiments of the present invention, an appropriate switch (such as, by way of non-limiting example, a Spectrum®-2 Ethernet Switch ASIC, commercially available from Mellanox Technologies, Ltd) may be used, as described further herein, to stream relevant events (such as, by way of non-limiting example, telemetry events) using remote direct memory access (RDMA), such as, by way of non-limiting example, RDMA over Converged Ethernet (RoCE); this allows achieving the necessary pps and managing latency requirements, while freeing CPU resources from needing to handle the network. Without limiting the generality of the foregoing, in certain exemplary embodiments non-Ethernet switches may alternatively be used, such as, for example, InfiniBand switches (which are also, for example, commercially available from Mellanox Technologies, Ltd).

In some exemplary embodiments of the present invention, handling of events (such as, by way of non-limiting example, telemetry events) is enabled using hardware-handled RoCE, which may comprise RoCE unreliable connection/s (UC). The term “hardware-handled”, as used herein, relates to communications in which (after opening a connection, which may involve the use of software), packets are sent via hardware without need of software intervention. One non-limiting example of such a system is described in U.S. Pat. No. 7,013,419 to Kagan et al, the disclosure of which is hereby incorporated herein by reference.

As described above in the general overview of telemetry systems, some such switch-based systems are believed to use one or more CPUs of the switch to poll cyclic direct memory access (DMA) buffers, analyze (“digest”) the result, and send the analyzed result to a collector. Such an approach is believed to us a high amount of CPU (both on the switch and on the collector), and to result in relatively slow packet handling; “slow” in this context refers to packet handling at a rate of a few hundreds of thousands of packets per second, perhaps as much as a few million packets per second. In some exemplary embodiments of the present invention using (as described above) a hardware-handled RoCE connection, the switch may be enabled to handle two or even three orders of magnitude more packets per second than in the approach just described, without requiring CPU utilization on either the collector or the switch side for sending packets (in general, only a small amount of CPU is required on the collector side for “pulling” packets out of local memory).

Due to the nature of RDMA, in which remote (collector) memory is directly accessed, there is no need to analyze (“digest”) information while storing; the analysis may take place entirely on the collector side when processing the previously-stored information. Thus, the solution is viable for providing microsecond-resolution telemetry or reporting of other events, which may be useful for (by way of non-limiting example) handling congestion control, handling of buffer problems, and handling microbursts. One specific non-limiting example is tap aggregation, in which one switch can collect information from a number of places (hosts, CPUs, etc.). In tap aggregation, as is known in the art, each switch products data, which is sent to a tap aggregator. A tap aggregator is generally a switch which performs aggregation (in some case, only performs aggregation), and then sends the aggregated packets onwards. In certain exemplary embodiments of the present invention enabling tap aggregation, improved performance may be achieved using RDMA, as described above and below.

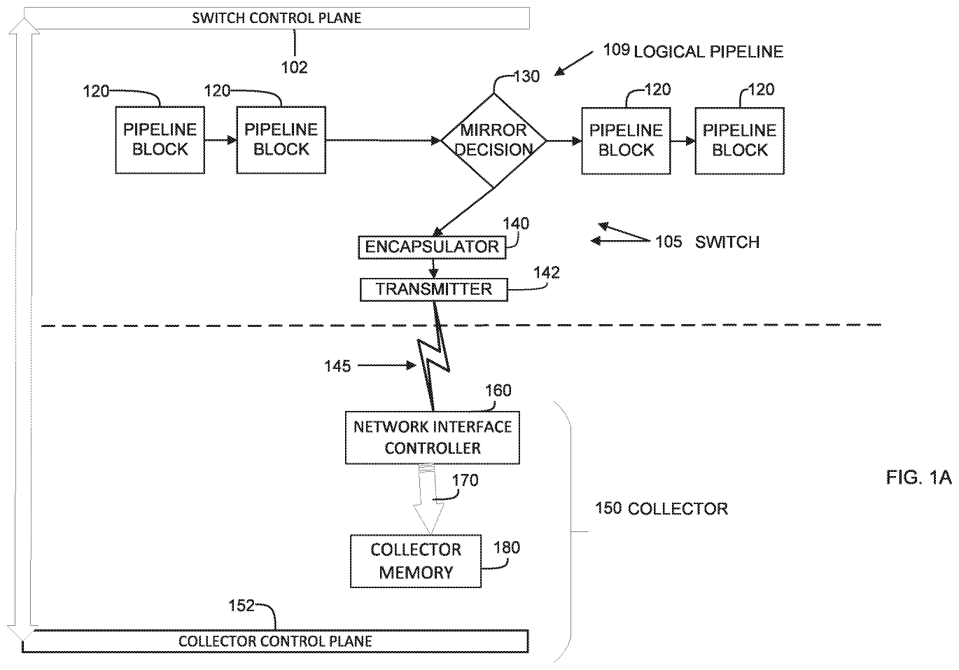

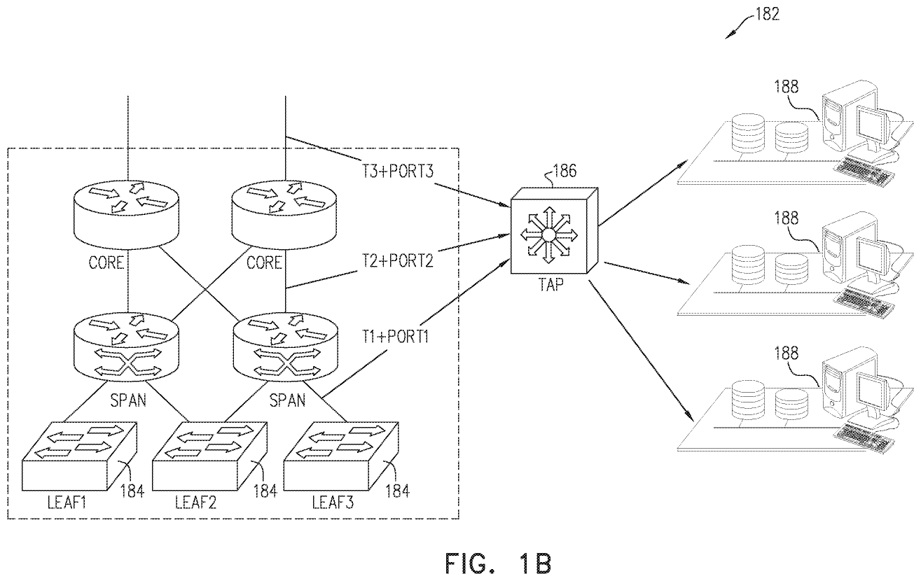

Reference is now made to FIG. 1A, which is a simplified block diagram illustration of a network information transmission system constructed and operative in accordance with an exemplary embodiment of the present invention. The system of FIG. 1 comprises a switch 105, which comprises a logical pipeline 109 for switching packets. (As stated above, the example of a switch is non-limiting; persons skilled in the art will appreciate that a router may also be used in certain exemplary embodiments of the present invention. The term “packet handling device” may be used herein to designate either a switch or a router.) The logical pipeline 109 is shown as comprising a plurality of pipeline blocks 120; only four such pipeline blocks 120 are shown for simplicity of depiction and description, it being appreciated that a larger (or smaller) number of pipeline blocks 120 may be comprised in the switch 105.

The switch 105 of FIG. 1 also comprises the following elements, the operation of which is described below:

a mirror decision unit 130;

an encapsulator 140; and

a transmitter 142.

The switch 105 of FIG. 1 is shown as being in communication, via a network connection 145, with a collector 150. It is appreciated that, in certain exemplary embodiments of the present invention, the network connection 145 and the collector 150 are external to those exemplary embodiments, so that the subcombination comprising the switch 105 comprises an exemplary embodiment of the present invention.

The collector 150 of FIG. 1 comprises a network element, such as (by way of non-limiting example) a network interface controller (NIC) 160 on the side of the collector. One non-limiting example of an appropriate NIC for such a connection is a ConnectX NIC, commercially available from Mellanox Technologies, Ltd.

The collector 150 of FIG. 1 also comprises a direct memory access (DMA) channel 170, and a collector memory 180.

An exemplary mode of operation of the system of FIG. 1 is now briefly described. The switch 105 (in particular, generally a control plane 102 of the switch, in communication with a control plane 152 of the collector) opens an Unreliable Connection (UC) via RoCE (generally but not necessarily using RoCEv2, which is known to use unreliable connections), over the network connection 145, to the collector 150. While the example of a UC is used herein, it is appreciated that a reliable connection could alternatively be used.

The UC is generally opened from the switch to the collector 150 via the network interface controller 160. In some exemplary embodiments, opening such a UC may be done in software using and appropriate software stack (such as, by way of non-limiting example, SoftRoCE (a version of which is publicly available via the World Wide Web at github.com/SoftRoCE); it being particularly understood that the example of software (and in particular of SoftRoCE) in this context is not meant to be limiting.

Once a UC as described immediately above is opened, packets may be sent from the switch 105 to the collector 150. Packets which are to be sent are, in general, appropriately encapsulated by the encapsulator 140 (as is known for RoCEv2, for example) for sending. The encapsulated packets are sent by the transmitter 142 via the UC to the collector 150.

Reference is now additionally made to FIG. 1B, which is a partly pictorial, partly block-diagram illustration of a tap aggregation system, useful for understanding certain modes of operation of the exemplary embodiment of FIG. 1A.

The tap aggregation system of FIG. 1B, generally designated 182, may in general, except as described herein, be similar to tap aggregation systems which are well known in the art, in which a plurality of leaf switches 184 (shown for sake of simplicity of description as leaf switch 1, leaf switch 2, and leaf switch n, it being appreciated that a smaller or larger number of leaf switches may be used) produce data which is aggregated at a network tap 186, for transmission onwards to one or more collector systems 188 (again, for sake of simplicity of description three collector systems 188 are shown, it being appreciated that a smaller or larger number of collector systems may be used.

In exemplary embodiments, the network tap 186 comprises a network information transmission system such as that shown and described with reference to FIG. 1A, so that it will be appreciated that the functions and advantages described above with reference to FIG. 1A can be realized in the case of a tap aggregation system.

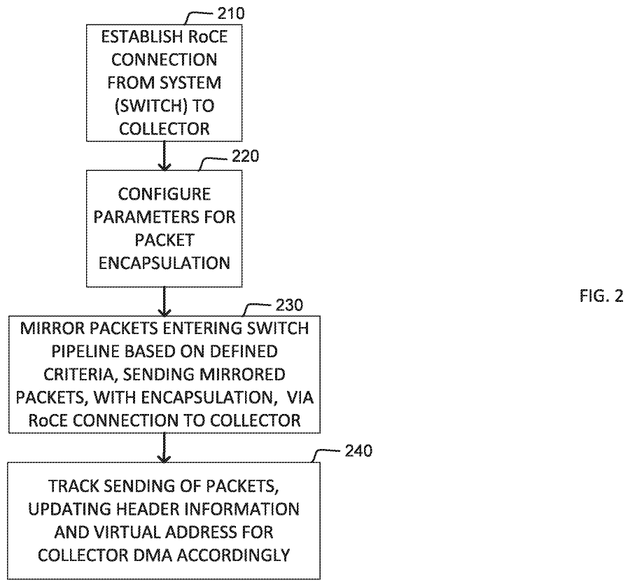

Reference is now additionally made to FIG. 2, which is a simplified flowchart illustration of an exemplary method of operation of the system of FIG. 1.

As described above, a RoCE connection is opened from the switch 100 to the collector 150 (step 210).

Parameters are configured for packet encapsulation (step 220). Without limiting the generality of the foregoing, the parameters are configured by a control plane, such as the switch control plane 102 of FIG. 1A. The following specific non-limiting example of appropriate encapsulation parameters relates to RoCEv2:

The following parameters are configured for initial encapsulation, these parameters being well-known in the art of RoCE:
BTH header:
(base) Virtual Address, Source/Destination Queue Pair, Partition key
RETH header:
Remote Key
IP/UDP headers:
Source/Destination IP, Source/Destination Port
DMA length (configurable per session)

As is well known, switches generally have a pipeline architecture. In general, any packet entering a switch pipeline can be “mirrored”; in the case of exemplary embodiments of the present invention, mirroring may take place for sending the mirrored packet to the remote collector.

While mirroring of packets is described herein, and encapsulating and sending mirrored packets is described herein, this is only one non-limiting example of certain exemplary embodiments of the present invention. Packets may be chosen (as described immediately below in the case of mirroring), and their destination altered so that the packets are encapsulated and sent without mirroring, for example.

A non-limiting list of exemplary situations in which a packet might be mirrored for sending to the remote collector include:

flow-based reasons (based, by way of non-limiting example, on a match in a match action table; such reasons may include, by way of non-limiting example: input port; associated VLAN; user-defined rules in general; destination IP address 5-tuple [flow identifier], and so forth);

in a case of a dropped packet;

in a case of reaching a buffer threshold (such as reaching a low buffer-space-remaining level);

in a case of reaching a latency threshold (such as latency too high);

in a case of a packet entering the switch via a particular ingress port, or exiting the switch via a particular egress port (the particular ports being, in exemplary cases, determined in advance or determined dynamically); and

in a case where a packet is a control packet.

Packets entering the switch are mirrored based on defined criteria (such as in accordance with the exemplary situations described immediately above) and mirrored packets are sent, with encapsulation, via RoCE to the collector 150 (step 230). Packets continue to be sent; the switch 150 tracks the fact that additional packets are sent; and the switch updates information that is placed in the header/s of the subsequent packets, updating header information, and virtual address information for DMA at the collector 150, accordingly (step 240).

In exemplary embodiments of the present invention, when a first (initial) packet is mirrored at the switch for encapsulation and transmission to the collector, the first packet is encapsulated, generally in accordance with the parameters for initial encapsulation referred to above.

As subsequent packet/s are mirrored for encapsulation and transmission to the collector, RoCE header fields are updated by the switch before encapsulation, in accordance (following the example above) with the following:

the PSN (packet sequence number) is incremented with each packet sent;

the virtual address (at the collector) is updated as follows:

[base address+(PSN*DMA length)] % DMA_COUNT

In the virtual address update equation immediately above, DMA_COUNT indicates the maximum number of packets that may be put into the available memory space, such that one must “wrap around” when available space is full.

Each subsequent packet is then sent to the collector, via an IP network. It is appreciated that, in exemplary embodiments of the present invention, the IP network and the collector are not comprised in the exemplary embodiments.

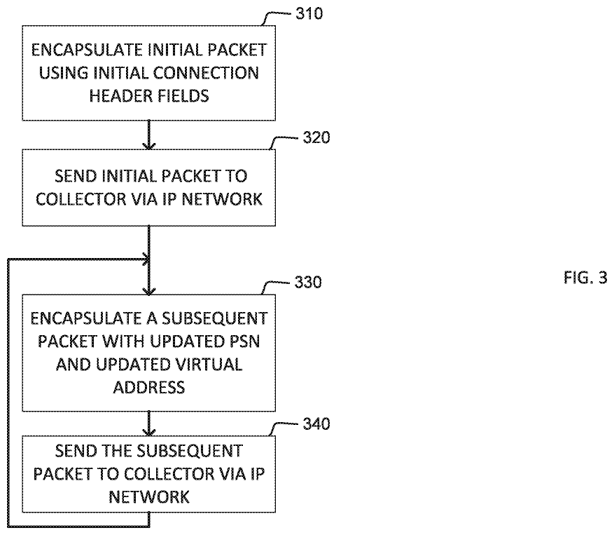

Reference is now additionally made to FIG. 3, which is a simplified flowchart illustration of an exemplary method of operation of a portion of the method of FIG. 2, specifically comprising encapsulation and sending of packets via RoCE over the (IP) network connection 145.

An initial packet is encapsulated using initial connection header fields, such as those described above with reference to RoCEv2 (step 310). The initial packet is sent to the collector 150 via the network connection 145 (step 320).

A subsequent packet is encapsulated, as described above, with an updated PSN and updated virtual address (step 330), and is sent to the collector 150 via the IP network 145 (step 330). The method then continues at step 330 for the next packet. No explicit end of the method of FIG. 3 is shown, indicating that an essentially unlimited number of packets may be sent from the switch 105 to the collector 150, it being appreciated that, in practice, at some point sending of packets may cease.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A network information transmission system comprising:
a packet handling device comprising:
a control plane configured to open a remote direct memory access (RDMA) connection with a destination external to the network information transmission system;
an encapsulator configured to encapsulate one or more packets traversing said packet handling device, producing one or more encapsulated packets; and
a transmitter configured to transmit said one or more encapsulated packets, via said RDMA connection, to the destination external to the network information transmission system.

2. The network information transmission system according to claim 1, and wherein said packet handling device comprises one of the following: a switch; and a router.

3. The network information transmission system according to claim 1, and wherein said one or more encapsulated packets comprise telemetry information.

4. The network information transmission system according to claim 1, and wherein the packet handling device further comprises a mirror decision unit configured to duplicate said one or more packets before encapsulation thereof, and
the encapsulator encapsulates said one or more duplicated packets.

5. The network information transmission system according to claim 1 and wherein said RDMA connection transits an internet protocol (IP) network.

6. The network information transmission system according to claim 5 and wherein said RDMA connection comprises a RDMA over converged Ethernet (RoCE) connection.

7. The network information transmission system according to claim 6 and wherein said RoCE connection comprises one of: an unreliable connection (UC); and a reliable connection.

8. The network information transmission system according to claim 7 and wherein said RoCE connection comprises a RoCEv2 connection.

9. The network information transmission system according to claim 1 and wherein said destination external to the network information transmission system comprises a collector system.

10. The network information transmission system according to claim 9 and wherein said collector system comprises a network element and collector memory.

11. The network information transmission system according to claim 10 and wherein said network element comprises a network interface controller (NIC).

12. A network information transmission method comprising:
in a packet handling device of a network information transmission system:
opening a remote direct memory access (RDMA) connection with a destination external to the network information transmission system;
encapsulating one or more packets traversing said packet handling device, producing one or more encapsulated packets; and
transmitting said one or more encapsulated packets, via said RDMA connection, to the destination external to the network information transmission system.

13. The method according to claim 12, and wherein said one or more encapsulated packets comprise telemetry information.

14. The method according to claim 12, and further comprising duplicating said one or more packets before encapsulation thereof, and wherein said one or more duplicated packets are encapsulated.

15. The method according to claim 12 and wherein said RDMA connection transits an internet protocol (IP) network.

16. The method according to claim 15 and wherein said RDMA connection comprises a RDMA over converged Ethernet (RoCE) connection.

17. The method according to claim 16 and wherein said RoCE connection comprises one of: an unreliable connection (UC); and a reliable connection.

18. The method according to claim 12 and wherein said destination external to the network information transmission system comprises a collector system.

19. The method according to claim 18 and wherein said collector system comprises a network element and collector memory.

20. The method according to claim 19 and wherein said network element comprises a network interface controller (NIC).
